(19) United States
(12) Patent Application Publication
(10) Pub. No.: US 2011/0236171 A1
(43) Pub. Date: Sep. 29, 2011

(54) WORKPIECE TRANSPORT METHOD AND WORKPIECE TRANSPORT DEVICE

(76) Inventors: Masayuki Yamamoto, Osaka (JP); Chouhei Okuno, Osaka (JP)

(21) Appl. No.: 13/050,151

(22) Filed: Mar. 17, 2011

(30) Foreign Application Priority Data
Mar. 23, 2010 (JP) 2010-066505

(51) Int. Cl. B65G 47/91

(52) U.S. Cl. 414/752.1; 414/800

(57) ABSTRACT

Two or more pads having through holes formed therein concentrically at given pitches are provided on a U-shaped holding arm. Compressed air is sprayed from the pad to a protection sheet to generate negative pressure between a holding surface of the holding arm and the protection sheet for suspendingly holding a wafer with the protection sheet floating, or the pad suction-holds and transports a rear face of the wafer having an exposed circuit surface.

### BACKGROUND OF THE INVENTION

(1) Field of the Invention

This invention relates to a workpiece transport method and device for transporting a workpiece including an electronic substrate such as a semiconductor wafer (hereinafter, appropriately referred to as a “wafer”) and a printed substrate, or a sheet, in a contact or non-contact manner in accordance with types of workpiece.

(2) Description of the Related Art

A holder is known that transports while suspendingly holding a wafer as a substrate in a non-contact manner. The holder forms a chamber between upper and lower cases. Tow or more through holes are provided in a lower case side. Gases are sprayed from the through holes toward a wafer surface through supply of gases in the chamber. Specifically, spray of gases to the wafer surface leads to a region of negative pressure between the holder and the wafer to float and suspendingly hold the wafer due to a Bernoulli effect. See Japanese Patent Publication No. 2008-168413.

However, high-temperature processing such as gold evaporation is recently performed to the rear face of the back ground wafer. The adhesive tape is an organic material, and is melted through high-temperature processing. Accordingly, the adhesive tape is separated from the wafer surface prior to the high-temperature processing. A new adhesive tape is joined to the wafer surface after the high-temperature processing. Consequently, it is necessary to repeat joining and separating of the adhesive tape, which causes complicated processing. As a result, such disadvantages may arise as an upsized apparatus configuration and a reduced processing speed.

The wafer having proper rigidity may be transported through suction-holding of a rear face thereof without contacting a circuit surface thereof to a holding member, although a surface-protective adhesive tape is kept separated from the wafer after a back grinding process.

The wafer, however, needs to be held on the ring frame via the adhesive tape prior to a dicing process. Here, it is necessary for the adhesive tape to be joined to the rear face of the wafer while being supported the circuit surface thereof and pressed and rolled by a joining roller.

In such case, the exposed circuit surface of the wafer may directly be pressed onto a metal holding table, or the wafer may slide in a rolling direction of the joining roller, which may cause damages in the circuit surface.

Inventors have come the conclusion that a member protecting the circuit surface is provided between the holding table and the wafer for solving the above problem. Here, a protection member of high maintainability is preferable. Thus, Inventors decided to utilize a sheet.

However, an air-permeable sheet is needed where the wafer has to be suction-held on the holding table via the sheet. There arises a new problem that the sheet on the holding member for suction-holding has a reduced suction force, and the sheet cannot be suction-held and transported positively.

The conventional holding device using a Bernoulli effect may transport only the sheet. However, there arises a problem that the holding device cannot suspendingly hold and transport the wafer of a large diameter or a certain thickness having a large self-weight.

### SUMMARY OF THE INVENTION

This invention has one object to provide a workpiece transport method and device for transport a workpiece accurately regardless of types of workpiece.

This invention discloses a workpiece transport method for transporting a workpiece. The method includes the step of transporting the workpiece through switching to suction-holding of the workpiece on a holding surface of a holding member in accordance with the workpiece, or to suspendingly holding of the workpiece while floating due to negative pressure generated between the holding surface and a surface of the workpiece through spraying compressed air from the holding surface of the holding member to the workpiece.

According to the above method, holding form of the holding member may be switched to a contact or non-contact manner in accordance with the workpiece. In a contact manner, the workpiece is sucked with the holding member. In a non-contact manner, compressed air is sprayed to the workpiece for suspendingly holding thereof.

For instance, in a non-contact manner, compressed air is sprayed from the holding member to the workpiece as under. That is, gases are sprayed from two or more through holes to the surface of the workpiece for suspendingly holding the workpiece. The through holes are radial and tapered from the same position as a channel formed inside the holding member toward the holding surface of the holding member, and formed concentrically at give pitches. For instance, in a contact manner, two or more through holes suction-hold the workpiece.

Accordingly, various types of workpiece may be transported in the workpiece transport step. For instance, the semiconductor wafer thinned after the back grinding process having the surface-protective adhesive tape joined thereto, the semiconductor wafer having no protective adhesive tape joined thereto, or the air-permeable sheet having difficulty in suction-holding may be transported.

In other words, where the semiconductor wafer having difficulty in bending and deforming through joining of the protective adhesive tape to the workpiece for reinforcement, or the single semiconductor wafer having rigidity and a weight to be difficult in bending and deforming with no adhesive tape joined thereto is adopted, the workpiece may be transported while contacting to the holding member. Moreover, the semiconductor wafer or the sheet may be transported with the holding member in a non-contact manner in which the workpiece is bent and deformed regardless of the presence or absence of the adhesive tape. Here, the sheet may be transported in a non-contact manner regardless of air-permeability. Consequently, the workpiece may be transported without damages regardless types thereof.

Examples of the holding member include the following ones. That is, a holding member having a U-shaped tip end and pads with through holes formed on a U-shaped holding surface thereof at given intervals. A holding member having an annular tip end and pads with through holes formed on an annular holding surface thereof at given intervals. A holding member having a circular tip end and pads with through holes formed on a circular holding surface thereof at given intervals.

Moreover, the holding member may have no pad. In other words, the holding member has the holding surface having through holes directly formed therein.

This invention also discloses a workpiece transport device for transporting a workpiece. The device includes a holding member for holding the workpiece; a compressor in communication with the holding member via a channel; and a controller for performing switching control of the compressor so as to spray compressed air toward the workpiece from a holding surface of the holding member to generate negative pressure between the holding surface and the workpiece for suspendingly holding and transporting the workpiece, or to suction-hold the workpiece with the holding arm for transporting the workpiece.

According to this configuration, the compressor in communication with the holding member via the channel is switched to be driven under positive or negative pressure, whereby the workpiece may be transported through switching to suction-holding thereof with the holding member or to suspendingly holding thereof in a non-contact manner.

The holding member in the foregoing configuration is configured as follows.

Two or more through holes are formed so as to be in communication with the channel inside from the holding surface. Two or more through holes are formed concentrically as one group on the holding surface at given pitches. Moreover, two or more groups of through holes are arranged on the holding surface.

It is more preferable that the through hole is tapered from the same position as the channel communicated with inside of the holding member toward the holding surface.

According to this configuration, compressed air sprayed on the workpiece surface from the holding member flows on the surface smoothly and radially. Consequently, efficient generation of negative pressure between the holding surface of the holding member and the workpiece surface due to an ejector effect and a Bernoulli effect as well as of static pressure on the rear face of the workpiece due to an air-cushion effect may be achieved, which results in suspendingly holding of the workpiece positively while floating.

The foregoing configuration may include a reverse driving mechanism for reversely driving the holding member upside down. According to this configuration, the workpiece to be suction-held for transportation may be placed on the holding table while the workpiece turns upside down.

Additional features of the invention will be preset forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view showing a configuration of adhesive tape joining apparatus.

FIG. 2 is a front view of the adhesive tape joining apparatus.

FIG. 3 is a front view partly showing a transport mechanism.

FIG. 4 is a plan view partly showing the transport mechanism.

FIG. 5 is a front view of a workpiece transport device.

FIG. 6 is a plan view showing a principal portion of the workpiece transport device.

FIG. 7 is a plan view partly showing a principal portion of a holding arm.

FIG. 8 is an enlarged plan view of a pad of the holding arm.

FIG. 9 is a sectional view on arrow A-A of the pad of the holding arm in FIG. 7.

FIG. 10 is a plan view showing a movement structure of the workpiece transport device and a frame transport device.

FIGS. 11 and 12 are front views each partly showing a forward/backward movement structure of the workpiece transport device and the frame transport device.

FIGS. 13 to 22 are explanatory views each showing the adhesive tape joining apparatus.

FIG. 23 is a perspective view of a mount frame.

FIGS. 24 and 25 are plan views each showing the holding table according to apparatus in one modified embodiment.

### DESCRIPTION OF THE PREFERRED EMBODIMENTS

One embodiment of the present invention is now described below with reference to the drawings.

In this embodiment, a case is to be described as one example where a workpiece transport device is provided with adhesive tape joining apparatus for manufacturing a mount frame by holding a rear face of a semiconductor wafer (hereinafter, simply referred to as a “wafer”) thinned through a back grinding process on a ring frame via an adhesive tape.

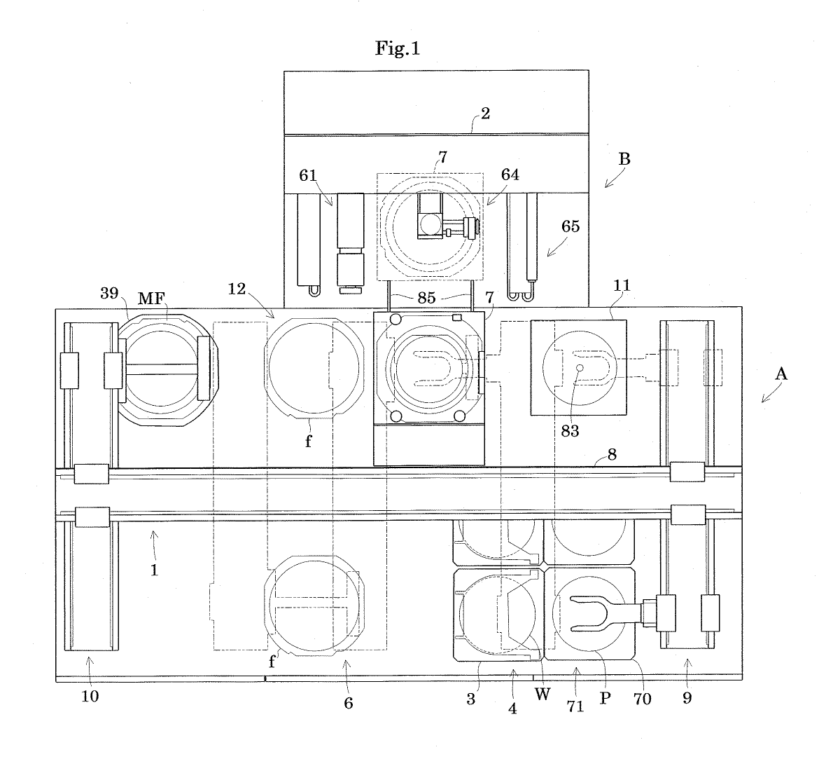

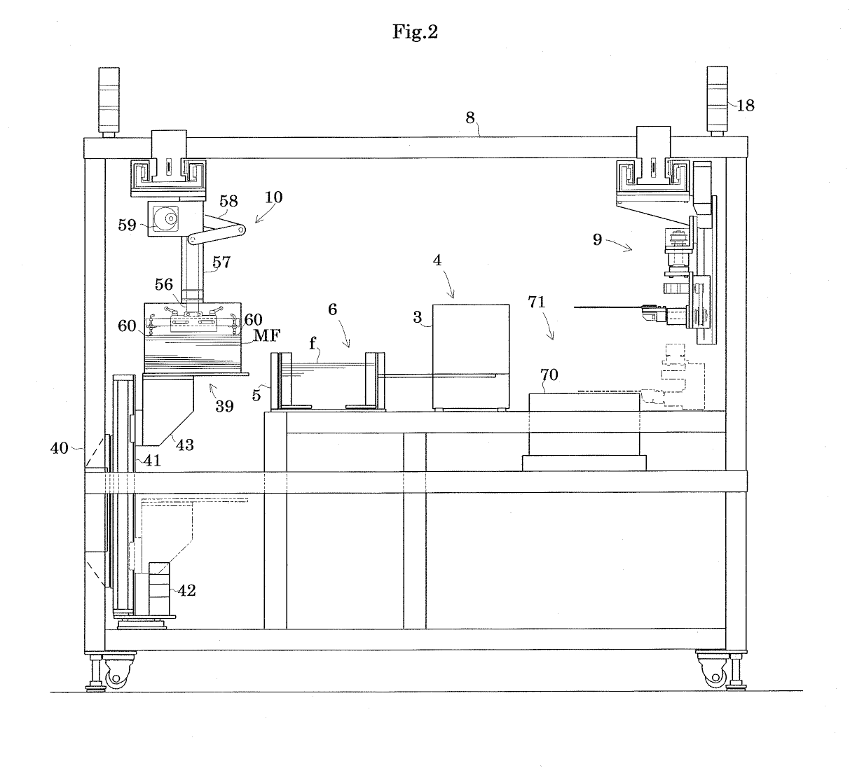

FIG. 1 is a plan view of adhesive tape joining apparatus. FIG. 2 is a front view thereof.

As shown in FIG. 1, the adhesive tape joining apparatus includes a laterally-extending rectangular section A and a protrusion section B connected at a center of the rectangular section A so as to protrude rearward from the center. Here, in the following description, a longitudinal direction of the rectangular section A is referred to as a horizontal direction. Moreover, a direction orthogonal to the horizontal direction is referred to as a front side and a back side (upper and lower sides in FIG. 1.)

A transport mechanism 1 is disposed on the rectangular section A. Herein, the transport mechanism 1 transports a wafer W, a ring frame f and a mount frame MF. On the other hand, an adhesive tape joining section 2 is disposed on the protrusion section B. Herein, the adhesive tape joining section 2 joins an adhesive tape DT to a ring frame f and a wafer W for manufacturing a mount frame MF.

As shown in FIGS. 1 and 2, a wafer supply section 4 is disposed on the rectangular section A at a rightward front side with respect to the center of the rectangular section A, and a sheet supply section 71. The wafer supply section 4 houses the wafers W in a cassette 3 in a stack manner for supplying them. The sheet supply section 71 houses surface-protection sheets P in a case 70 in a stack manner for supplying them. In this embodiment, two cassettes 3 and two cases 70 are arranged in parallel.

Moreover, this embodiment adopts one of the cases 70 in the sheet supply section 71 for collecting a used protection sheet P.

Moreover, a frame supply section 6 is disposed on the rectangular section A at a leftward front side with respect to the center of the rectangular section A. The frame supply section 6 includes a case 5 that houses ring frames fin a stack manner for supplying them. Further, a holding table 7 is disposed on the rectangular section A at a rear side near the center of the rectangular section A (near the adhesive tape joining section 2) for transferring a wafer W and a ring frame f each placed thereon to the adhesive tape joining section 2.

Here, the protection sheet P in this embodiment adopts an air-permeable inserting paper. For instance, the protection sheet P may be an elastomer having many minute through holes formed therein due to foaming expansion.

As shown in FIG. 19, the holding table 7 has a wafer holding table 72 at a center thereof and a frame holder 73. The wafer holding table 72 holds the protection sheet P and the wafer W. The wafer holder 73 surrounds the wafer holding table 72.

The wafer holding table 72 is a metal chuck table. The wafer holding table 72 is in communication with an external vacuum device formed inside thereof via a channel. The wafer holding table 72 suction-holds the wafer W placed thereon via the air-permeable protection sheet P. The wafer holding table 72 moves upward and downward with a cylinder 84. Here, the holding table 72 is not limited to metal, but may be formed of a ceramic porous material.

The frame holder 73 has a step formed therein with an equal thickness to that of the frame. The frame holder 73 is configured such that an upper surface of the ring frame f is equal in level to the top surface of the frame holder 73 upon placing the ring frame fin the step. Moreover, the frame holder 73 is configured such that the surface of the wafer W is equal in level to that of the ring frame f upon placing the protection sheet P and the wafer W on the wafer holding table 73.

As shown in FIG. 1, the holding table 7 reciprocates with a drive mechanism along a rail 85 between a set position of the wafer W and the adhesive tape joining section 2.

The transport mechanism 1 includes a workpiece transport device 9 and a frame transport device 10. The workpiece transport device 9 is supported at a right side of a guide rail 8 so as to reciprocate horizontally. Herein, the guide rail 8 is provided horizontally at an upper side of the rectangular section A so as to extend horizontally. On the other hand, the frame transport device 10 is supported at a left side of the guide rail 8 so as to move horizontally. Moreover, an aligner 11 is provided at a rightward rear side of the rectangular section A. Herein, the aligner 11 performs alignment of the wafer W with a notch or an orientation mark. Further, an aligner 12 is provided at a rear side of the frame supply section 6, and performs alignment of the ring frame f.

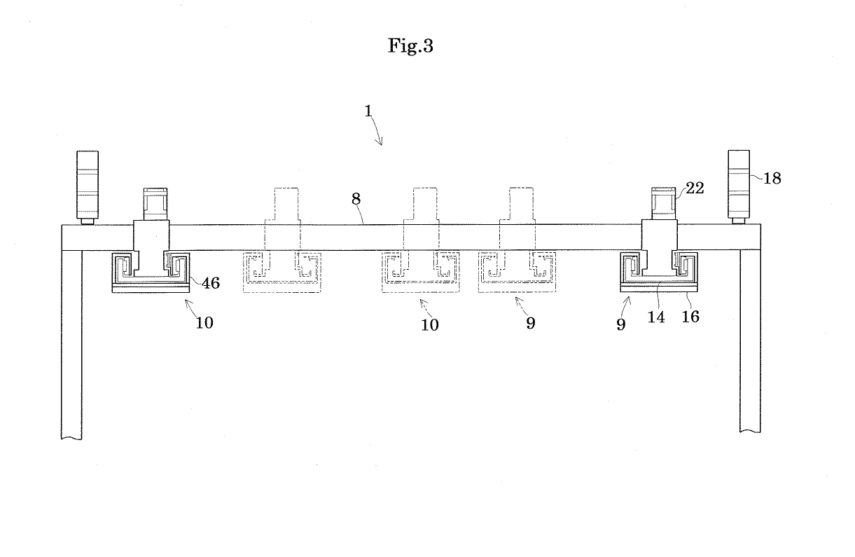

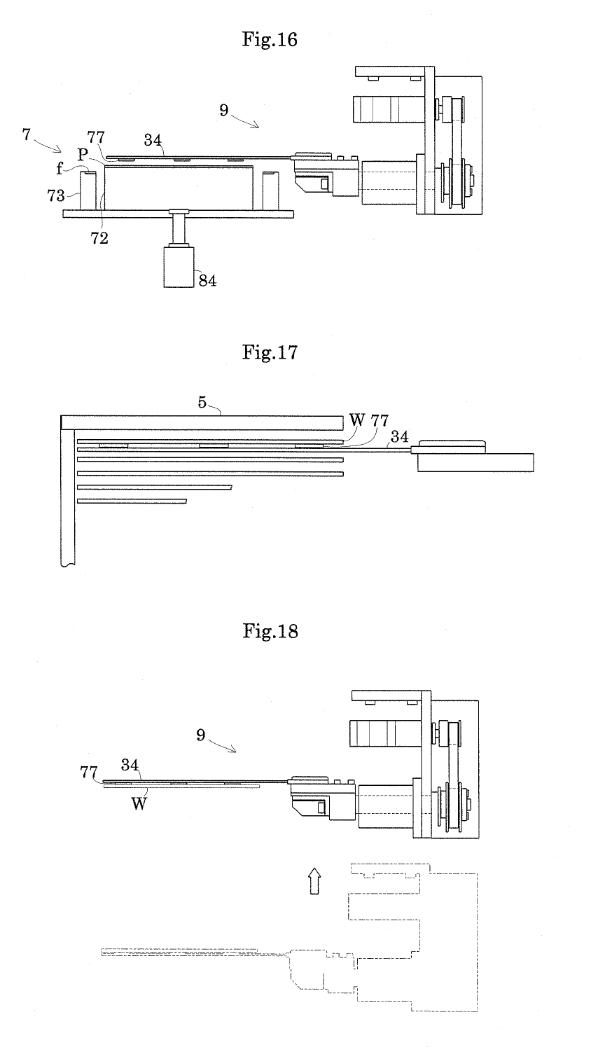

The workpiece transport device 9 pulls out a protection sheet P from the case 70 and a wafer W from the cassette 3, and then transports the protection sheet P and the wafer W horizontally and forward/backward. Further, the workpiece transport device 9 may turn the wafer W upside down. FIGS. 3 to 12 show a detailed structure of the workpiece transport device 9.

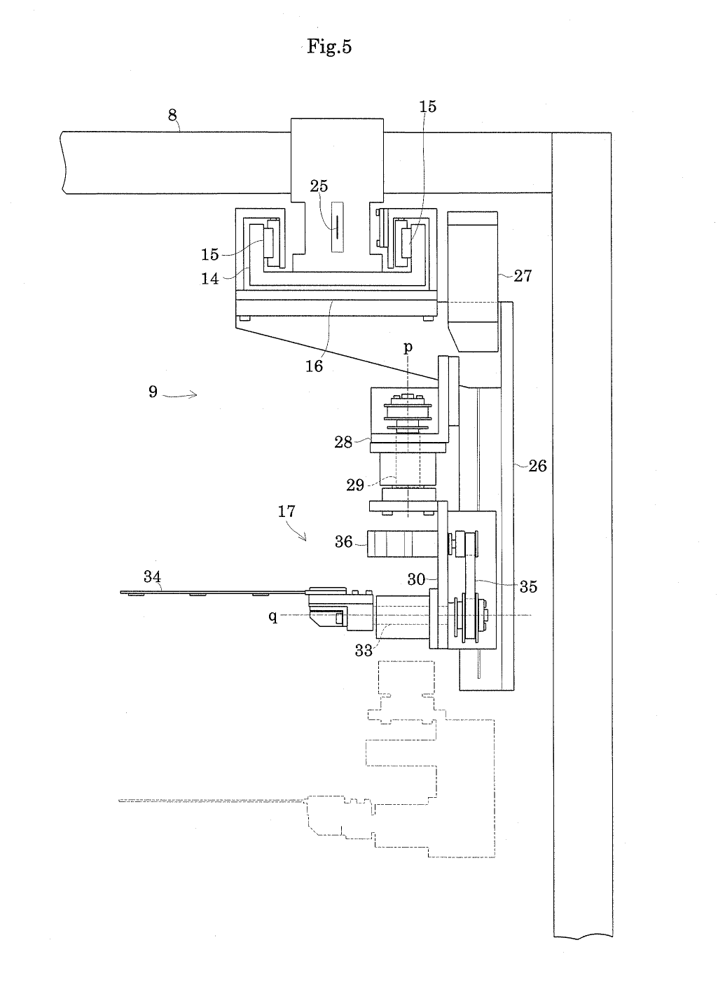

As shown in FIGS. 3 and 5, the workpiece transport device 9 includes a horizontally movable table 14 that moves horizontally along the guide rail 8. The horizontally movable table 14 corresponds to a horizontally movable table 44 in the frame transport device 10. The transport device 9 also includes a forward/backward movable table 16 that moves forward/backward along a guide rail 15 provided in the horizontally movable table 14. The forward/backward movable table 16 corresponds to a forward/backward movable table 46 in the frame transport device 10. The workpiece transport device 9 also includes a holding unit 17 provided below the forward/backward movable table 16 for holding the wafer W and the protection sheet P.

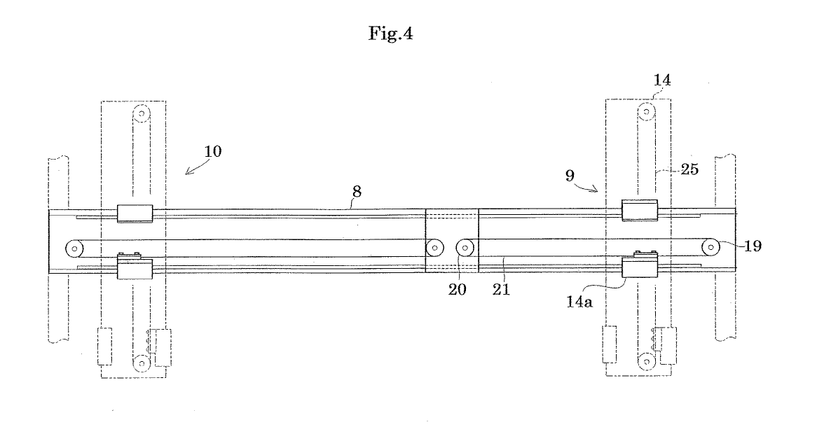

As shown in FIGS. 3 and 4, a driving pulley 19 is pivotally supported near a right end of the guide rail 8 and is driven by a motor 18 so as to rotate forward/backward. Moreover, an idling pulley 20 is pivotally supported near a center of the guide rail 8. Further, a belt 21 is wound between the driving pulley 19 and the idling pulley 20. A slide engagement section 14a in the horizontally movable table 14 is connected to the belt 21. Consequently, the belt 21 rotates forward/backward, and accordingly the horizontally movable table 14 moves horizontally.

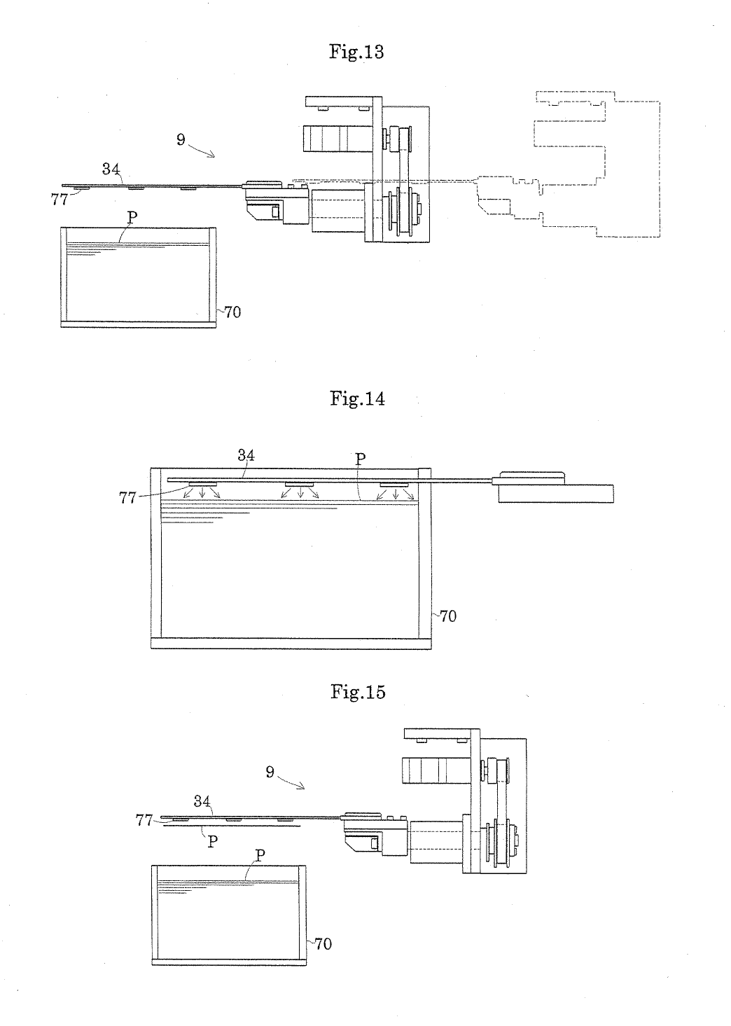

As shown in FIGS. 10 through 12, a driving pulley 23 is pivotally supported adjacent to a rear end of the horizontally movable table 14 and is driven by a motor 22 so as to rotate forward/backward. Moreover, an idling pulley 24 is pivotally supported near a front end of the horizontally movable table 14. Here, the motor 22 corresponds to a motor 52, the driving pulley 23 to a driving pulley 53, and the idling pulley 24 to an idling pulley 54, respectively, in the frame transport device 10. Further, a belt 25 is wound between the driving pulley 23 and the idling pulley 24. Here, the belt 25 corresponds to the belt 55 in the frame transport device 10. A slide engagement section 16a in the forward/backward movable table 16 is connected to the belt 25 (55). Here, the slide engagement section 16a corresponds to a slide engagement section 46a in the frame transport device 10. The belt 25 rotates forward/backward, and accordingly the forward/backward movable table 16 moves forward/backward.

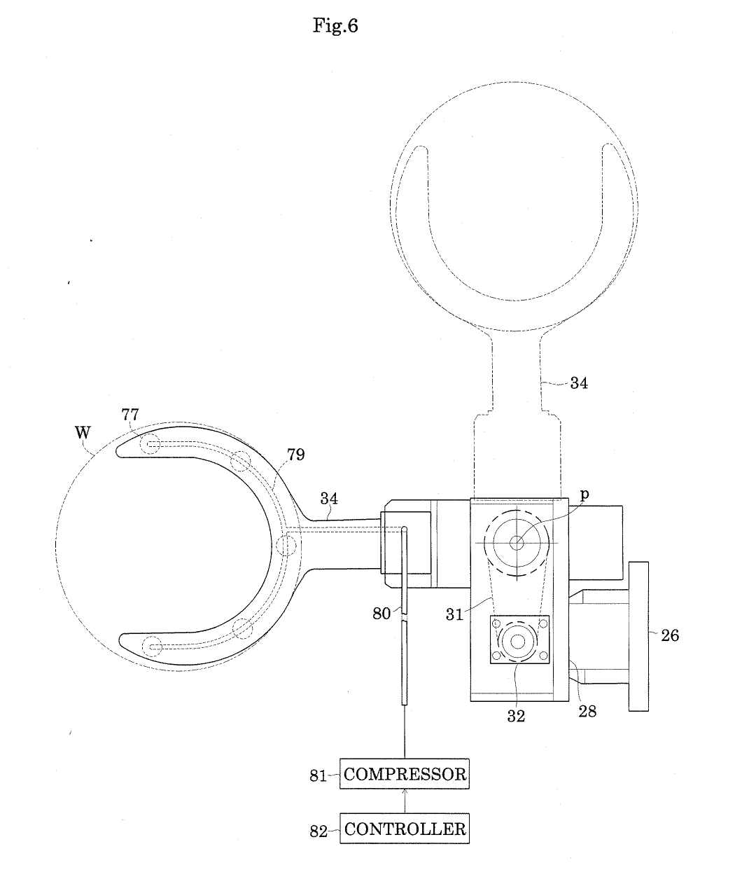

As shown in FIGS. 5 and 6, the holding unit 17 includes an inverted L-shaped support frame 26, a lifting table 28, a turning table 30, a pivoting motor 32, a holding arm 34, and a reverse rotating motor 36. The support frame 26 is connected to a lower surface of the horizontally movable table 16. A motor 27 drives the lifting table 28 in a screw feed manner along a vertical frame of the support frame 26. The turning table 30 is pivotably supported via a turning axis 29 for pivoting about a vertically oriented axis p. The pivoting motor 32 is wound around the turning axis 29 via a belt 31 for interlocking with each other. The holding arm 34 is supported on a lower surface of the turning table 30 for reverse rotation about a horizontal axis q. The reverse rotating motor 36 is wound around the turning axis 33 via a belt 35 for interlocking with each other. Here, the holding arm 34 corresponds to the holding member in this invention.

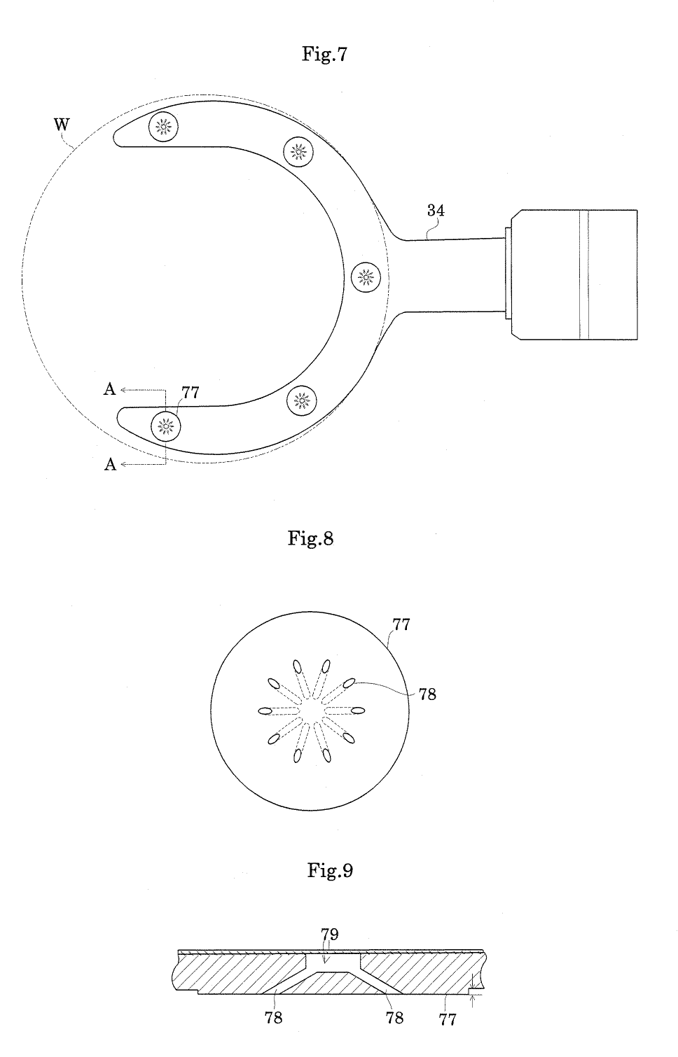

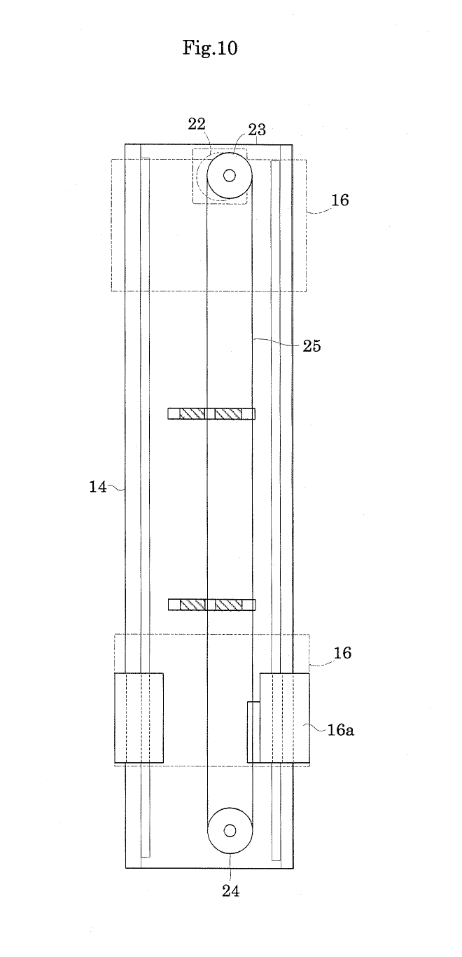

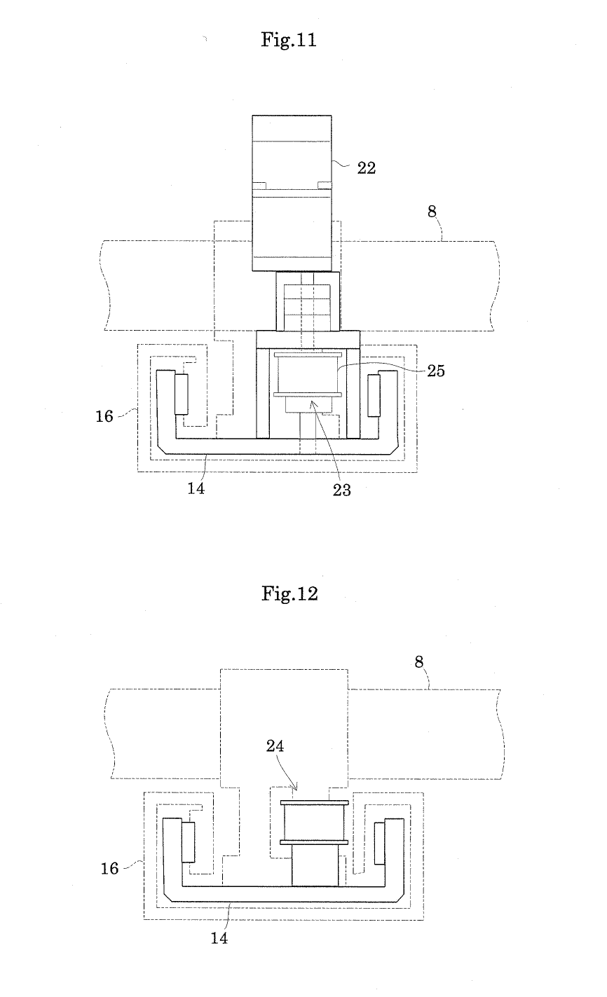

As shown in FIGS. 6 and 7, the holding arm 34 is U-shaped. The holding arm 34 has pads 77 formed on a holding surface thereof that project slightly. As shown in FIG. 8, the pad 77 has ellipse holes (with a small diameter of approximately 0.2 mm here in this embodiment) inwardly from the surface of the pad 77 that are formed concentrically at given pitches. As shown in FIGS. 6 and 9, the holes 78 are in communication with the same position as a channel 79 formed inside the holding arm 34. Each hole 78 is tapered from the channel 79 inside the holding arm 34 toward the holding surface. The pads 77 are placed in a given position on the holding surface of the holding arm 34. The holding table 34 is in communication with a compressor 81 via the channel 79 formed therein and a connection channel 80 connected to a proximal end of the channel 79.

A controller 82 switches driving of the compressor 81. Specifically, the compressor 81 is driven under negative pressure, whereby the pads 77 of the holding arm 34 suction-hold the rear face of the wafer W. Moreover, the compressor 81 is switched to drive under positive pressure, whereby the holding arm 34 turns upside down and compressed air is sprayed on the protection sheet P from the holes directed downward. That is, the holding aim 34 may achieve efficient generation of negative pressure between the holding surface thereof and the protection sheet P due to an ejector effect and a Bernoulli effect as well as of positive pressure on the rear face of the protection sheet P due to an air-cushion effect. According to these effects, only an uppermost protection sheet P floats and is held suspendingly by the holding arm 34.

Use of the movable structure described above may achieve the following advantages. That is, the suction-held wafer W may be moved in forward/backward and horizontal directions, and may be turned about the vertically-oriented axis p with the holding arm 34. As shown in FIG. 5, the wafer W may also be turned upside down through the reverse rotation about the horizontally-oriented axis q.

Moreover, the protection sheet P may be moved forward/backward and horizontally while being suspendingly held with the holding arm 34.

As shown in FIG. 2, a collection section 39 is disposed at a left side of the frame supply section 6. Herein, the collection section 39 collects to stack mount frames MF manufactured through joining the wafer W to the ring frame f via the adhesive tape DT. The collection section 39 includes an upright rail 41 fixedly connected to an apparatus framework 40, and a lifting table 43 driven by a motor 42 so as to move vertically in a screw feed manner along the upright rail 41. Accordingly, the frame supply section 6 allows the mount frame MF to be placed on the lifting table 43 and to move downward in a pitch feed manner.

The frame transport device 10 pulls out an uppermost one of stacked ring frames f from the frame supply section 6 in succession, and then transports each ring frame fin the horizontal and forward/backward directions. The horizontal and forward/backward movement structures of the ring frame transport device 10 are similar to those of the workpiece transport device 9.

As shown in FIGS. 1 and 2, the frame holding unit 47 includes an upright frame 56 connected to a bottom side of the forward/backward movable table 46, a lifting frame 57 supported so as to slide vertically along the upright frame 56, a bendable link mechanism 58 for moving the lifting frame 57 vertically, a motor 59 for bending the bendable link mechanism 58 forward/backward, and suction pads 60 provided at corners on lower ends of the lifting frame 57. Accordingly, the suction pads 60 suction-hold stacked ring frames fin order from an uppermost one that are stacked on the lifting table 43, and then move upward. Thus, the ring frames f may be transported forward/backward and horizontally. Herein, a position of the suction pad 60 is slidingly adjustable in the horizontal direction in accordance with a size of the ring frame f.

As shown in FIGS. 2, 20, and 21, the adhesive tape joining section 2 includes a tape supply section 61 for housing a wide adhesive tape (a dicing tape) DT in a roll form, a joining roller 62, a separation roller 63, a tape cutting mechanism 64, and a tape collection section 65.

Description will be given next of basic operation for joining the adhesive tape DT to the rear face of the wafer W according to the apparatus in the foregoing exemplary embodiment.

First, the frame holding unit 47 in the frame transport device 10 suction-holds the ring frame f from the frame supply unit 6, and places it on the aligner 12.

The frame holding unit 47 releases its suction-holding of the ring frame f and moves upward. Then, the aligner 12 performs alignment of the ring frame f. Thereafter, the frame holding unit 47 again suction-holds the ring frame f for transporting it onto the holding table 7, and places the wafer W on the frame holder 73 concentric with the wafer W.

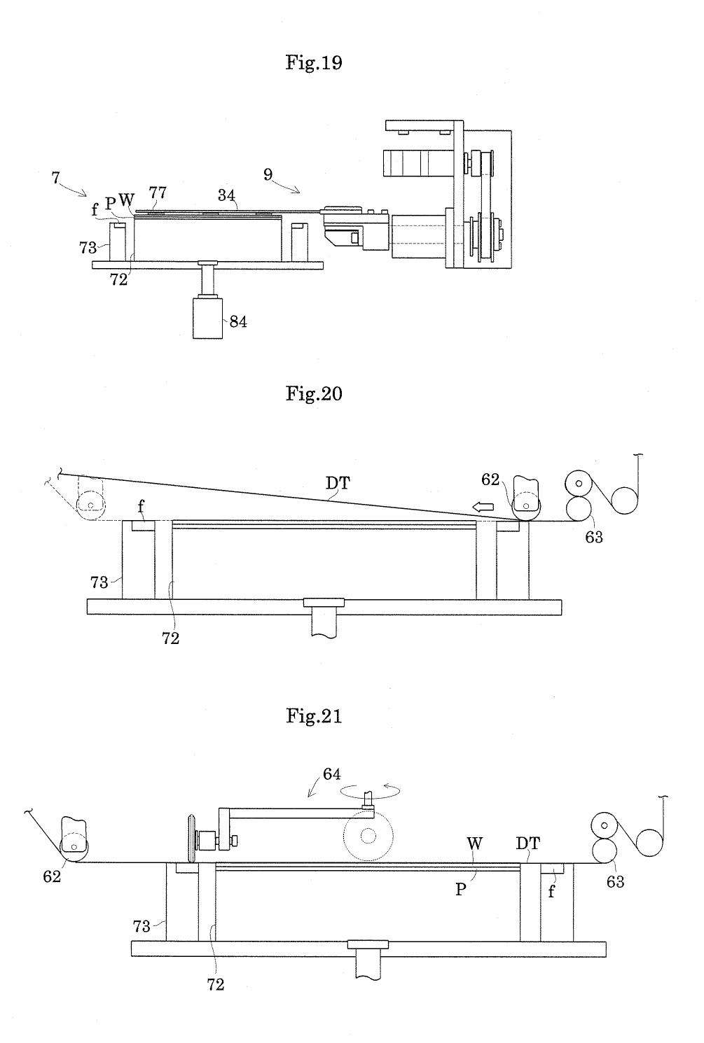

As shown in FIG. 13, the holding arm 34 moves upward above the case 70 in the sheet supply unit 71 while the pads 77 are directed downward. As shown in FIG. 14, the holding arm 34 moves downward into a given level for approaching the uppermost protection sheet P. The compressor 81 is driven under positive pressure in this state for spraying compressed air onto the protection sheet P from the pads 77 in the holding arm 34. Then, airflow smoothly flowing radially on the surface of protection sheet P generates a region of steady negative pressure between the holding surface and the protection sheet P, which results in float of the protection sheet P.

As shown in FIG. 15, the floating protection sheet P is moved above the holding table 7 while being suspendingly held with the holding arm 34. As shown in FIG. 16, the wafer holding table 72 has already moved upward to a position where the surface thereof is higher than the surface of the frame holder 73. The holding arm 34 moves downward to a level where the protection sheet P is brought into contact with the wafer holding table 72. The compressor 81 stops driving to place the protection sheet P on the wafer holding table 72. The protection sheet P on the wafer holding table 72 is aligned with an alignment pin, etc.

The workpiece transport device 9 transports the protection sheet P and returns to the wafer supply section 4. Subsequently, the workpiece transport device 9 turns the pads 77 in the holding arm 34 upside down so that they are directed upward. As shown in FIG. 17, the holding arm 34 moves forward/backward in this state between the wafers W housed in a stack manner in the cassette 5 of the wafer supply section 4 for contacting the pads 77 to the rear face of the wafer W. There, the wafers W having the circuit surface are directed upward. Upon contacting of the pads 77 to the rear face of the wafer W, the compressor 81 is driven under negative pressure to pull out the wafer W through suction-holding of the rear face of the wafer W. The wafer W is transported above the aligner 11 while being suction-held with the holding arm 34.

The aligner 11 suction-holds the rear face of the wafer W at a center thereof with a suction pad 83 (see FIG. 1) projecting from a center of the aligner 11. Simultaneously, the holding arm 34 releases suction-holding of the wafer W and retracts. The suction pad 83 is housed within the table and the aligner 11 performs alignment of the wafer W based on a notch, etc., of the wafer W. Upon completion of the alignment, the suction pad 83 suction-holding the wafer W projects from a surface of the aligner 11, where the holding arm 34 moves to suction-hold the rear face of the wafer W. Thereafter, the pad 83 releases its suction and moves downward.

As shown in FIG. 18, the holding arm 34 moves upward into a given level while suction-holds the rear face of the wafer W. Then, the holding arm 34 turns upside down such that the circuit surface of the wafer W is directed downward. Thereafter, as shown in FIG. 19, the holding arm 34 moves above the holding table 7 to place the wafer W on the protection sheet P on the wafer holding table 72 while the circuit surface of the wafer W is directed downward. The wafer holding table 72 suction-holds the wafer W placed thereon via the protection sheet P.

Upon completion of setting the wafer W and the ring frame f on the holding table 7, the wafer holding table 72 moves downward. The upper surface of the wafer W is equal in level to that of the ring frame f. Thereafter, the holding table 7 moves to the adhesive tape joining section 2 along the rail 85.

When the holding table 7 reaches a transport position of the tape joining section 2, the joining roller 62 moves downward to roll on the adhesive tape DT from right to left in plane as shown in FIG. 20. Consequently, the adhesive tape DT is joined to the ring frame f and the rear face of the wafer W. When the joining roller 62 reaches its termination position, the tape cutting mechanism 64 moves downward to cut the adhesive tape DT along the ring frame f while turning a round-blade cutter, as shown in FIG. 21.

Upon completion of cutting the adhesive tape DT, the tape cutting mechanism 64 moves upward, and the separation roller 63 moves from right to left as shown in FIG. 22, thereby winding up and collecting an unnecessary tape after cut out.

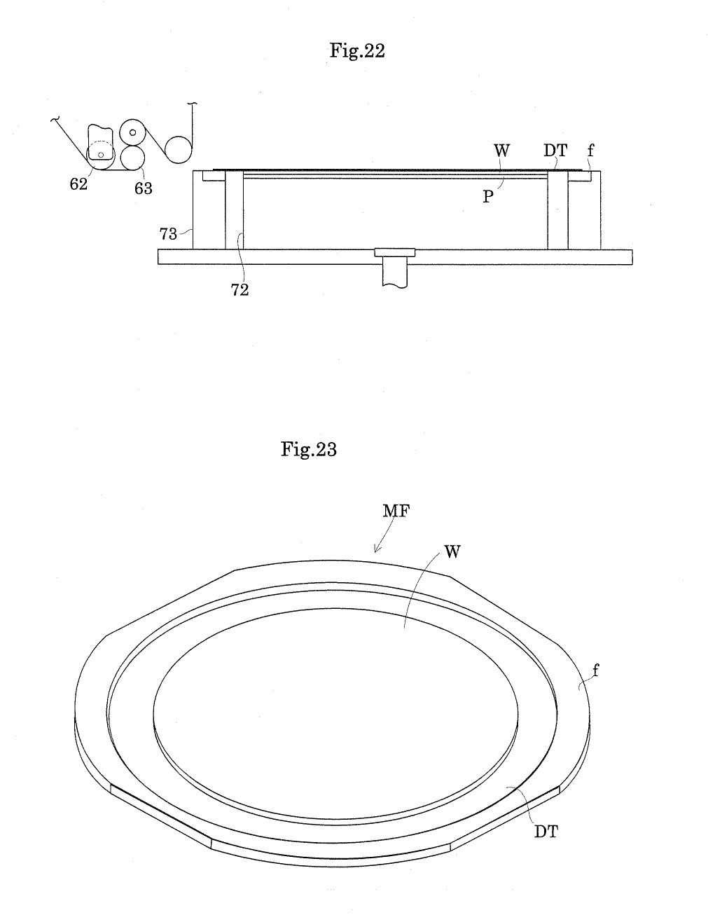

Upon completion of manufacturing the mount frame MF as shown in FIG. 23, the holding table 7 moves to a setting position of the rectangular section A in FIG. 1, and then stops. Here, the frame holding unit 47 suction-holds and transports a manufactured mount frame MF for collecting it into the collection section 39. Moreover, the workpiece transport mechanism 9 moves to the holding table 7. The holding arm 34 suspendingly holds the used protection sheet P, and transports the protection sheet P to the collecting case 70 in the sheet supply section 71 in the above state.

Thus, a round of basic operation is completed as mentioned above. The similar operation is to be repeated hereinafter.

According to the apparatus in the foregoing embodiment, one workpiece transport device 9 may transport the protection sheet P unable to be suction-held and transported and the wafer W necessary for being suction-held. Moreover, the through hole 78 formed in the suction pad of the holding arm 34 has a tapered channel having an elliptical aperture surface directed outward. Compressed air sprayed from the though hole 78 toward the protection sheet P generates airflow smoothly flowing on the surface of the protection sheet P. Accordingly, a region of steady negative pressure is generated between the holding surface of the holding arm 34 and the protection sheet P, which results in suspendingly holding of the protection sheet P with stability.

Moreover, the through hole 78 has a minute diameter and a small contact area with the rear face of the wafer W to be suction-held. Consequently, the thinned wafer W having reduced rigidity and easy to be bent and deformed through the back grinding process is not bent inwardly through drawing of the wafer W into the through hole 78. That is, no damage occurs in the wafer W.

This invention may be embodied as the following aspects.

In the apparatus in the foregoing exemplary embodiment, the air-permeable inserting paper is adopted as the protection sheet P. The non-air-permeable protection sheet may be adopted. For instance, examples of the protection sheet P include an elastic silicon sheet and a protection sheet having uneven steps formed thereon in a two-dimensional array at given pitches.

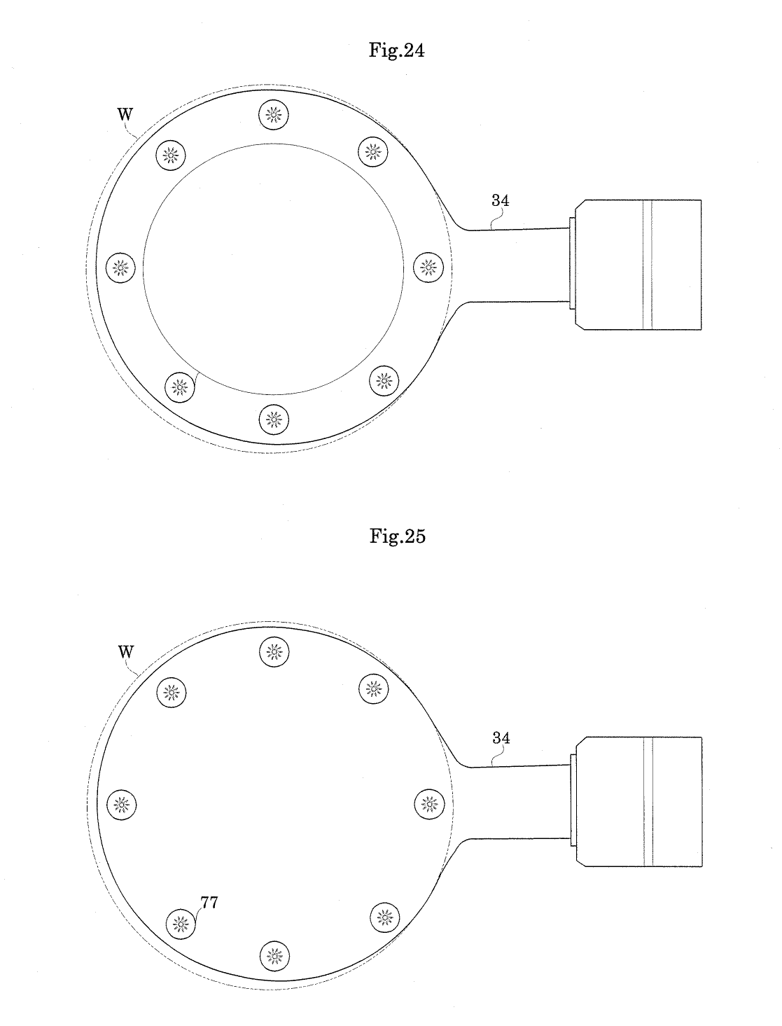

The holding arm 34 in the foregoing exemplary embodiment may be formed as follows. For instance, as shown in FIG. 24, the holding arm 34 may have an annular tip end and pads 77 with through holes formed at given pitches. Moreover, as shown in FIG. 25, the holding arm 34 may include pads 77 having through holes formed at two or more portions on a circular arm with the same diameter as the wafer W.

The holding arm 34 in the above exemplary embodiment has an aspect of suction-holding the wafer W and transporting the protection sheet P in a non-contact manner. The holding arm 34 may has an aspect of transporting the wafer W in a non-contact manner. In this aspect, the holding arm 34 suspendingly holds and transports the protection sheet P and the wafer W, in this order, from the case 70 in which the wafers W with the circuit surface thereof being directed downward are housed in a stack manner having the protection sheets P interposed therebetween.

The holding arm 34 in the above exemplary embodiment has the holding surface having through holes 78 directly formed therein. In other words, the holding arm having no pad 77 may be adopted.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A workpiece transport method for transporting a workpiece, comprising the step of:
transporting the workpiece through switching to suction-holding of the workpiece on a holding surface of a holding member in accordance with the workpiece, or to suspendingly holding of the workpiece while floating due to negative pressure generated between the holding surface and a surface of the wafer through spraying compressed air from the holding surface of the holding member to the workpiece.

2. The workpiece transport method according to claim 1, wherein
upon transporting the workpiece through suspendingly holding thereof, gases are sprayed from through holes to the surface of the workpiece for suspendingly holding the workpiece, the through holes being radial and tapered from a same position as a channel formed inside the holding member toward the holding surface of the holding member, and formed concentrically at give pitches, and
upon holding the workpiece, the through holes suction-hold the workpiece.

3. The workpiece transport method according to claim 1, wherein
the workpiece is a semiconductor wafer.

4. The workpiece transport method according to claim 1, wherein
the workpiece is an air-permeable sheet.

5. The workpiece transport method according to claim 1, wherein
the holding member is U-shaped, and has pads with through holes formed on a U-shaped holding surface thereof at given intervals.

6. The workpiece transport method according to claim 1, wherein
the holding member is annular, and has pads with through holes formed on an annular holding surface thereof at given intervals.

7. The workpiece transport method according to claim 1, wherein
the holding member is circular, and has pads with through holes formed on a circular holding surface thereof at given intervals.

8. A workpiece transport device for transporting a workpiece, comprising:
a holding member for holding the workpiece;
a compressor in communication with the holding member via a channel; and
a controller for performing switching control of the compressor so as to spray compressed air toward the workpiece from a holding surface of the holding member to generate negative pressure between the holding surface and the workpiece for suspendingly holding and transporting the workpiece, or to suction-hold the workpiece with the holding arm for transporting the workpiece.

9. The workpiece transport device according to claim 8, wherein
the holding member has through holes formed so as to be in communication with the channel inside from the holding surface, and
the through holes has holes concentrically formed at given pitches and are arranged on the holding surface.

10. The workpiece transport device according to claim 9, wherein
the through hole is tapered from a same position as the channel communicated with inside of the holding member toward the holding surface.

11. The workpiece transport device according to claim 8, further comprising:
a reverse driving mechanism for reversely driving the holding member upside down.

12. The workpiece transport device according to claim 8, wherein
the through hole is formed in the pad projecting from the holding surface.
